(19) United States
(12) Patent Application Publication
(10) Pub. No.: US 2013/0316295 A1
(43) Pub. Date: Nov. 28, 2013

(54) STAVE COOLER FOR A METALLURGICAL FURNACE

(71) Applicants: Nicolas Maggioli, Thionville (FR); Nicolas Mousel, Dudelange (LU); Jean-Paul Simoes, Walferdange (LU); Paul Tockert, Berbourg (LU)

(72) Inventors: Nicolas Maggioli, Thionville (FR); Nicolas Mousel, Dudelange (LU); Jean-Paul Simoes, Walferdange (LU); Paul Tockert, Berbourg (LU)

(73) Assignee: PAUL WURTH S.A., Luxembourg (LU)

(21) Appl. No.: 13/984,296

(22) PCT Filed: Jan. 31, 2012
(86) PCT No.: PCT/EP2012/051556

§ 371 Date: Aug. 8, 2013

(30) Foreign Application Priority Data
Feb. 8, 2011 (LU) LU 91 788

(51) Int. Cl. F27D 9/00

(52) U.S. Cl. CPC F27D 9/00
USPC 432/77

(57) ABSTRACT

A stave cooler for a metallurgical furnace, in particular for a blast furnace, including a panel-like body having a front face for facing the interior of the metallurgical furnace and an opposite rear face; and at least one internal coolant passage arranged within the panel-like body, where the at least one shaft, protrudes from the front face of the panel-like body.

### TECHNICAL FIELD

The present invention generally relates to a stave cooler for a metallurgical furnace.

### BACKGROUND ART

Such stave coolers for a metallurgical furnace are well known in the art. They are used to cover the inner wall of the outer shell of the metallurgical furnace, such as e.g. a blast furnace or electric arc furnace, to provide: (1) a heat evacuating protection screen between the interior of the furnace and the outer furnace shell; and (2) an anchoring means for a refractory brick lining, a refractory guniting or a process generated accretion layer inside the furnace. Originally, the stave coolers have been cast iron plates with cooling pipes cast therein. As an alternative to cast iron staves, copper staves have been developed. Nowadays most stave coolers for a metallurgical furnace are made of copper, a copper alloy or, more recently, of steel.

A copper stave cooler for a blast furnace is e.g. disclosed in German patent DE 2907511 C2. It comprises a panel-like body having a hot face (i.e. the face facing the interior of the furnace) that is subdivided by parallel grooves into lamellar ribs. The object of these grooves and ribs, which preferably have a dovetail (or swallowtail) cross-section and are arranged horizontally when the stave cooler is mounted on the furnace wall, is to anchor a refractory brick lining, a refractory guniting material or a process generated accretion layer to the hot face of the stave cooler. Drilled cooling channels extend through the panel-like body in proximity of the rear face, i.e. the cold face of the stave cooler, perpendicularly to the horizontal grooves and ribs.

The refractory brick lining, the refractory guniting material or the process generated accretion layer forms a protective layer arranged in front the hot face of the panel-like body. This protective layer is useful in protecting the stave cooler from deterioration caused by the harsh environment reigning inside the furnace. In practice, the protective layer is subject to erosion such that the panel-like body may be exposed to the harsh environment of the furnace, resulting, in turn, in the damage of the stave cooler.

Abrasion of the protective layer and the stave cooler may further be caused by the accumulation of unreduced material against the protective layer or the stave cooler, especially at the bosh and belly level of the metallurgical furnace.

### BRIEF SUMMARY

The invention provides an improved stave cooler for a metallurgical furnace, wherein the stave cooler does not display the aforementioned drawbacks.

A stave cooler for a metallurgical furnace, in particular for a blast furnace, in accordance with the present invention comprises a panel-like body having a front face for facing the interior of said metallurgical furnace and an opposite rear face; and at least one internal coolant passage arranged within said panel-like body. According to an aspect of the present invention, the at least one shaft of essentially circular cross-section, generally a plurality of such shafts, protrudes from said front face of said panel-like body.

It has been noted that, generally, the burden descending in proximity to the stave cooler is colder than the burden further towards the center of the metallurgical furnace. This can easily be explained by the presence of the stave coolers. However, it has also been noted that the process generated accretion layer forming the protective layer on the stave coolers does not form particularly well if the burden is “cold”. By using stave coolers with shafts, the flow of burden in proximity of the stave coolers is subjected to some turbulence. This causes the colder material to mix with hotter material, thus providing hotter material in front of the stave coolers. It has been noted that this hotter material more easily sticks to the stave coolers, thus building and maintaining the accretion layer, i.e. maintaining the protective layer which protects the stave cooler itself from wear.

The shafts on the front face of the panel-like body cause turbulence in the flow of burden past the front face of the stave cooler. This turbulence causes the burden to mix and prevents accumulation of unreduced material on the stave cooler, thus reducing erosion thereof. The turbulence caused by the shafts thus allows slowing down deterioration of the cooling panel and thereby prolongs its lifetime.

It should be noted that by “shafts of essentially circular cross-section” it will be understood that the cross-section of the shaft may be circular, oval or elliptical. In case of oval or elliptical cross-sections, these will be near circular, i.e. the largest diameter will not exceed 1.2 times the smallest diameter.

Advantageously, the front face comprises alternating retaining ribs and retaining grooves for retaining refractory material. Such grooves and ribs are useful in maintaining refractory material and process generated accretion layer against the front face of the panel-like body. Such a protective layer protects the panel-like body from excessive wear caused by the abrasive conditions reigning in the metallurgical furnace. Due to the turbulence created by the shafts, the protective layer is protected from erosion.

The panel-like body is preferably made from a material chosen in the group comprising copper, copper alloy, steel and steel alloy.

The shafts may be directly mounted on the front face of the panel-like body. Preferably, however, the panel-like body is provided with at least one through hole, the at least one through hole being arranged for receiving the at least one shaft therethrough.

The through holes may be cylindrical. Preferably, however, the through holes are conical, narrowing in direction of the front face.

Advantageously, the at least one shaft comprises a front portion for protruding from the front face of the panel-like body into the interior of the metallurgical furnace; and a connection portion for being arranged in the at least one through hole in the panel-like body. The connection portion preferably has a shape essentially corresponding to the shape of the at least one through hole.

The at least one shaft may further comprise a rear portion for protruding from the rear face of the panel-like body towards a shell of the metallurgical furnace.

According to an aspect of the invention, the at least one shaft may further comprise, on at least a portion of its length, an insert made from abrasion resistant material, the insert being arranged for facing a flux of incoming burden in the metallurgical furnace.

Advantageously, the at least one shaft comprises a cutout for receiving the insert. Such an insert may comprise a recess, the recess being arranged for facing a flux of incoming burden and for receiving burden thereon. The burden received in the recess covers and protects the insert. Indeed, any incoming burden does not directly impacting the insert but hits the already accumulated burden instead. The insert is thus protected from the harsh environment reigning in the metallurgical furnace.

Advantageously, the at least one shaft is removably connected to the panel-like body, thus being easily exchangeable in case of wear. Similarly, the insert may be removably connected to the shaft for replacing the insert if the latter is damaged.

The at least one shaft preferably protrudes from the panel-like body by a length corresponding to at least twice the thickness of the panel-like body.

According to an aspect of the invention, a heat pipe may be arranged within the at least one shaft. Such a heat pipe may be used to transfer heat between the shaft and the panel-like body.

The present invention further relates to a metallurgical furnace comprising a plurality of stave coolers as described above.

### BRIEF DESCRIPTION OF THE DRAWINGS

Preferred embodiments of the invention will now be described, by way of example, with reference to the accompanying drawings, in which:

FIG. 1 is a schematic cross-section through a cooling panel according to the invention;

FIG. 2 is a cross-section through the shaft of FIG. 1 according to a first embodiment of the invention;

FIG. 3 is a cross-section through the shaft of FIG. 1 according to a second embodiment of the invention;

FIG. 4 is a cross-section through the shaft of FIG. 1 according to a third embodiment of the invention;

FIG. 5 is a cross-section through the shaft of FIG. 1 according to a fourth embodiment of the invention.

### DESCRIPTION OF PREFERRED EMBODIMENTS

Stave coolers are used to cover the inner wall of an outer shell of a metallurgical furnace, as e.g. a blast furnace or electric arc furnace. The object of such stave coolers is to form: (1) a heat evacuating protection screen between the interior of the furnace and the outer furnace shell; and (2) an anchoring means for a refractory brick lining, a refractory guniting or a process generated accretion layer inside the furnace.

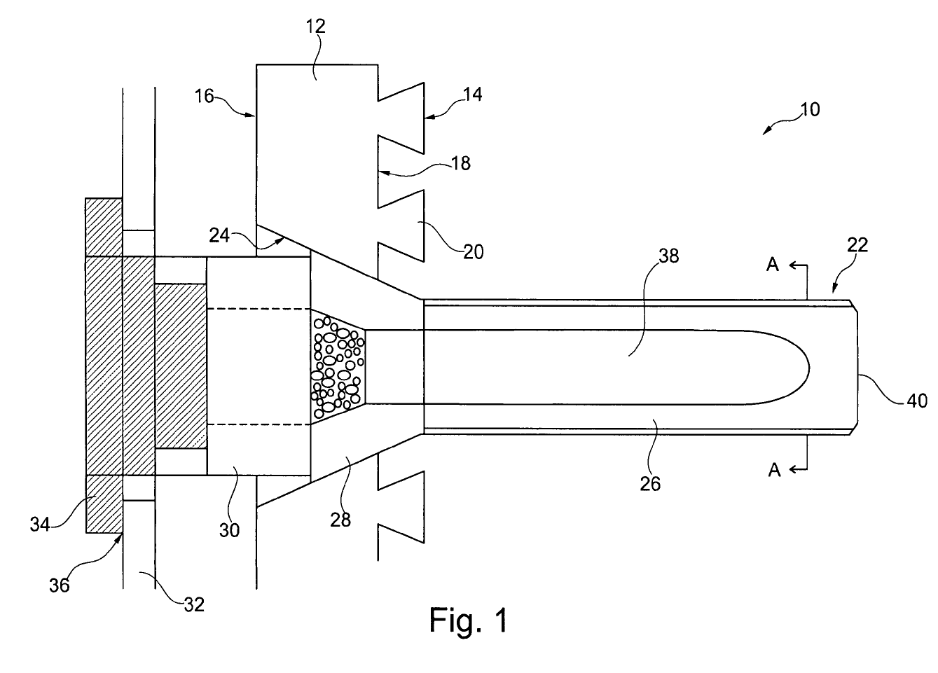

Referring now to FIG. 1, it will be noted that the stave cooler 10 has a panel-like body 12, which is e.g. made of a cast or forged body of copper, a copper alloy or steel. This panel-like body 12 has a front face 14, also referred to as hot face, which will be facing the interior of the furnace, and a rear face 16, also referred to as cold face, which will be facing the inner surface of the furnace wall. The panel-like body 12 generally has the form of a quadrilateral with a pair of long first and second edges and a pair of short upper and lower edges. Most modern stave coolers have a width in the range of 600 to 1300 mm and a height in the range of 1000 to 4200 mm. It will however be understood that the height and width of the stave cooler may be adapted, amongst others, to structural conditions of a metallurgical furnace and to constraints resulting from their fabrication process. The panel-like body 12 may be plane or curved such as to fit the curvature of the metallurgical furnace.

The stave cooler 10 further comprises connection pipes (not shown) on the rear face 16 for circulating a cooling fluid, generally water, through cooling channels (not shown) arranged within the panel-like body 12.

It will be noted that the front face 14 is subdivided by means of grooves 18 into lamellar ribs 20. Normally, the grooves 18 laterally delimiting the lamellar ribs 20 are directly cast into the panel-like body 12. These grooves 18 may however also be milled into the front face 14 of the panel-like body 12. When the stave cooler 10 is mounted in the furnace, the grooves 18 and lamellar ribs 20 are generally arranged horizontally. They form anchorage means for anchoring a refractory brick lining, a refractory guniting or a process generated accretion layer to the front face 14.

A preferred geometry of the grooves 18 and lamellar ribs 20, which warrants an excellent anchoring to the front face 14 for a refractory brick lining, a refractory guniting material or a process formed accretion layer, is also illustrated in FIG. 1. It will be noted that the grooves 18 have a dovetail (or swallowtail) cross-section, i.e. the inlet width of a groove 18 is narrower than the width at its base. Consequently, the ribs 20 have, with regard to the grooves 18, an inverse dovetail (or inverse swallowtail) cross-section.

According to the present invention, the stave cooler 10 is provided with at least one shaft 22 of essentially circular cross-section arranged on the front face 14 of the panel-like body 12 and protruding therefrom. According to a preferred embodiment of the invention, the shaft 22 is arranged in a through hole 24 arranged in the panel-like body 12. The through hole 24 is cone-shaped, narrowing in direction of the front face 14. Although not shown in the figures, the through hole may also be of a different shape, e.g. cylindrical.

Although only one shaft 22 is shown in FIG. 1, it should be appreciated that the stave cooler 10 is provided with a plurality of shafts 22 preferably arranged in a staggered relationship.

The shaft 22 has a front portion 26, a connection portion 28 and a rear portion 30. The front portion 26 protrudes from the panel-shaped body 12 for reaching into the metallurgical furnace. The connection portion 28 is arranged within the through hole 24 and has a shape corresponding to the shape of the through hole 24. The rear portion 30 protrudes from the rear face 16 of the panel-like body 12 towards a shell 32 of the metallurgical furnace. The rear portion 30 may reach through the shell 32 and be connected thereto by means of screws, welds or any other fixing means. A damaged shaft 22 may be replaced with an new or refurbished one by undoing the fixing means and retracting the shaft 22 through the panel-shaped body 12 and the shell 32. The new or refurbished shaft can then be installed. In the embodiment of FIG. 1, the fixing means is represented by an end plate 34 connected to the rear portion 30, the end plate 34 being connected to the outside surface of the shell 32 by means of a weld 36.

Within the shaft 22, a heat pipe 38 may be arranged. Such a heat pipe 38 may be obtained by drilling into the shaft 22 and subsequently plugging the end of the drilled hole. The heat pipe 38 is arranged so as to extend through the shaft 22 and reach from a region near the tip 40 of the shaft to a region in the connection portion 28 of the shaft 22. Such a heat pipe 38 allows heat transfer from the tip 40 of the shaft to the panel-like body 12 of the stave cooler 10, thus achieving effective cooling of the shaft 22.

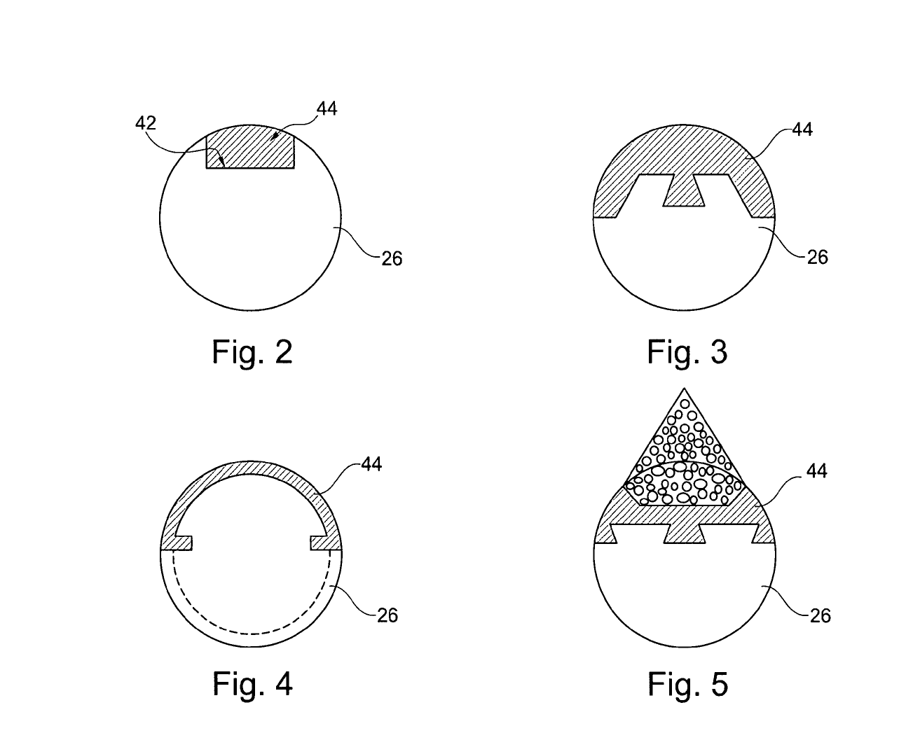

The front portion 26 of the shaft 22 may be provided with an insert, which can be more closely described by referring to FIGS. 2 to 5. These figures show a cut through the shaft 22 of FIG. 1 along line A-A.

According to a first embodiment, shown in FIG. 2, the front portion 26 of the shaft 22 comprises a cutout 42 of rectangular cross-section. An insert 44 of rectangular cross-section is arranged within the cutout 42. The insert 44 is arranged such that it faces the flux of incoming burden in the metallurgical furnace, i.e. the insert 44 faces upwards. The insert 44 may be removeably arranged in the cutout 42, such that it may be exchanged if the insert is worn or damaged. The insert 44 may extend over the whole length of the front portion 26 of the shaft 22, or over a portion of that length.

FIG. 3 shows a cutout 42 and insert 44 according to a second embodiment of the invention. The cutout 42 covers a large section of the shaft 22, essentially about half of its circumference. The cutout 42 is formed so as to create a dovetail-shaped portion. The insert 44 is shaped so as to correspond to the shape of the cutout 42.

FIG. 4 shows a cutout 42 and insert 44 according to a third embodiment of the invention. In this embodiment, the cutout 42 is formed so as to reduce the radius of the shaft 22 on about half of the circumference. Indentations 46 are provided for receiving lugs 48 of the insert 44 therein.

A fourth embodiment of the invention is shown in FIG. 5. According to this embodiment, the insert 44 comprises a recess 50 facing the flux of incoming burden. The recess 50 is such that burden 52 can be received thereon. The burden 52 resting on the insert 44 serves as a protection for the insert 44.

1. A stave cooler for a metallurgical furnace, in particular for a blast furnace, comprising:
a panel-like body having a front face for facing the interior of said metallurgical furnace and an opposite rear face; and
at least one internal coolant passage arranged within said panel-like body characterized by
at least one shaft of essentially circular cross-section protruding from said front face of said panel-like body.

2. The stave cooler according to claim 1, wherein said front face comprises alternating retaining ribs and retaining grooves for retaining refractory material.

3. The stave cooler according to claim 1 or 2, wherein said panel-like body is made from a material chosen in the group comprising copper, copper alloy, steel and steel alloy.

4. The stave cooler according to any of the previous claims, wherein said panel-like body is provided with at least one through hole, said at least one through hole being arranged for receiving said at least one shaft therethrough.

5. The stave cooler according to claim 4, wherein said at least one through hole is conical, narrowing in direction of said front face.

6. The stave cooler according to claim 4 or 5, wherein said at least one shaft comprises:
a front portion for protruding from said front face of said panel-like body into the interior of said metallurgical furnace; and
a connection portion for being arranged in said at least one through hole in said panel-like body.

7. The stave cooler according to claim 6, wherein said connection portion has a shape essentially corresponding to the shape of said at least one through hole.

8. The stave cooler according to claim 6 or 7, wherein said at least one shaft further comprises:
a rear portion for protruding from said rear face of said panel-like body towards a shell of said metallurgical furnace.

9. The stave cooler according to any of the previous claims, wherein said at least one shaft further comprises, on at least a portion of its length, an insert made from abrasion resistant material, said insert being arranged for facing a flux of incoming burden in said metallurgical furnace.

10. The stave cooler according to claim 9, wherein said at least one shaft comprises a cutout for receiving said insert.

11. The stave cooler according to claim 9 or 10, wherein said insert comprises a recess, said recess being arranged for facing a flux of incoming burden and for receiving burden thereon.

12. The stave cooler according to any of the previous claims, wherein said at least one shaft is removably connected to said panel-like body.

13. The stave cooler according to claims 9 to 12, wherein said insert is removably connected to said shaft.

14. The stave cooler according to any of the previous claims, wherein said at least one shaft protrudes from said panel-like body by a length corresponding to at least twice the thickness of said panel-like body.

15. The stave cooler according to any of the previous claims, wherein a heat pipe is arranged within said at least one shaft.

16. Metallurgical furnace comprising a plurality of stave coolers according to any one of the preceding claims.
